(19) United States
(12) Patent Application Publication
(10) Pub. No.: US 2015/0281993 A1
(43) Pub. Date: Oct. 1, 2015

(54) SYSTEM AND METHOD FOR BACKHAUL BASED SOUNDING FEEDBACK

(71) Applicant: Magnolia Broadband Inc., Englewood, NJ (US)

(72) Inventors: Phil F. Chen, Denville, NJ (US); Stuart S. Jeffery, Los Altos, CA (US); Kenneth Kludt, San Jose, CA (US); Haim Harel, New York, NY (US)

(21) Appl. No.: 14/472,759

(22) Filed: Aug. 29, 2014

Related U.S. Application Data
(60) Provisional application No. 61/971,685, filed on Mar. 28, 2014.

(51) Int. Cl. H04W 24/10

(52) U.S. Cl. CPC H04W 24/10; H04W 40/02

(57) ABSTRACT

A system and method for backhaul based explicit sounding feedback of 802.11 AP to AP channel state information (CSI) so that inter AP interference can be reduced and multiple APs transmissions that can occur simultaneously on the same radio channel. A modification may be made to APs such that they can accurately measure the CSI between them that in turn enables their respective beamformer to create pattern nulls toward each other while simultaneously developing pattern enhancements toward their intended station. An AP may send a sounding packet to its associated STAs, poll explicit feedbacks from STAs and receive backhaul CSI feedbacks from neighboring APs. There is no additional Wi-Fi overhead in physical layer. Backhaul feedback link is established through direct peer-to-peer (P2P) link which bypassed the sounding controller to reduce CSI feedback delay.

### CROSS REFERENCE TO RELATED APPLICATIONS

This application claims the benefit of prior U.S. Provisional Application Ser. No. 61/971,685 filed Mar. 28, 2014, which is incorporated herein by reference in its entirety.

### FIELD OF THE INVENTION

The present invention relates generally to the field of wireless communication, and more specifically to high efficiency Wi-Fi systems.

### BACKGROUND

Prior to setting forth a short discussion of the related art, it may be helpful to set forth definitions of certain terms that will be used hereinafter. Some of these terms are defined in the Institute of Electrical and Electronics Engineers (IEEE) 802.11 specification but it should be appreciated that the invention is not limited to systems and methods complying with the IEEE 802.11 specification.

The term “Wi-Fi” is used to refer to technology that allows communication devices to interact wirelessly based on the Institute of Electrical and Electronics Engineers (IEEE) 802.11 standards. The wireless communication may use microwave bands, e.g. in the 2.4 GHz to 5 GHz range.

The term “AP” is an acronym for Access Point and is used herein to define a device that allows wireless devices (known as User Equipment or “UE”) to connect to a wired network using Wi-Fi, or related standards. The AP usually connects to a router (via a wired network) as a standalone device, but it can also be an integral component of the router itself.

The term “UE” is an acronym for User Equipment(s) and is an example of a station, e.g. Wi-Fi station (STA) that may attach to an AP.

The term “associated STA” as used herein refers to a STA that is served by a certain AP, for example with a certain Service Set Identifier (SSID).

The term “station” or STA is a term used for any participant on the network, for example as used in the 802.11 specification. Both UEs and APs are considered in this context to be examples of stations. In the following the abbreviation STA is used for stations whose packets are detected by a Wi-Fi RDN station implementing embodiments of the invention.

BSS is acronym for Basic Service Set, which is typically a cluster of Stations associated with an AP dedicated to managing the BSS. A BSS built around an AP is called an infrastructure BSS.The term “backhaul” is used in the following to denote a communication path between two APs or base stations, for example using a different protocol from that used for wireless communication between an AP or base station and supported equipment or STA. The 802.11 specification does not provide for communication between APs. A backhaul link may operate outside a wireless, e.g. Wi-Fi, environment in which APs or base stations and associated UEs or other STAs are operating, or use one or more different channels from those used by APs to communicate with their associated stations. A backhaul link may use any combination of wired and wireless communication including but not limited to a cellular communication network, Ethernet, and the internet.

“Beacon transmission” refers to periodical information transmission which may include system information.

HT-LTF is an acronym for high throughput long training field as defined in the 802.11 specification.

MPDU is an acronym for media access code (MAC) protocol data unit as defined in the 802.11 specification.

NAV is an acronym for network allocation vector as defined in the 802.11 specification.

NDP is an acronym for null data packet.

PPDU is an acronym for physical layer convergence procedure (PLCP) protocol data unit as defined in the 802.11 specification.

The term “sounding” refers to a channel calibration procedure involving the sending of a packet, called a “sounding packet” from one participant on a network to another, for example as defined in the 802.11 specifications.

VHT is an acronym for very high throughput as defined in the 802.11 specification.

The specific Carrier Sense Multiple Access/Collision Avoidance (CSMA/CA) mechanism used in the 802.11 Media Access Control (MAC) is referred to as the distributed coordination function (DCF). A station that wishes to transmit first performs a clear channel assessment (CCA) by sensing the medium for a fixed duration, the DCF inter-frame space (DIFS).

SIFS, Short Inter Frame Space, as defined in the 802.11 specifications is the period between reception of the data frame and transmission of the ACK. SIFS is shorter than DIFS.

The term Clear Channel Assessment (CCA) as used herein refers to a CCA function, e.g. as defined in the 802.11 specification.

The term “MIMO” is an acronym for multiple input multiple output and as used herein, is defined as the use of multiple antennas at both the transmitter and receiver to improve communication performance. MIMO offers significant increases in data throughput and link range without additional bandwidth or increased transmit power. It achieves this goal by spreading the transmit power over the antennas to achieve spatial multiplexing that improves the spectral efficiency (more bits per second per Hz of bandwidth) or to achieve a diversity gain that improves the link reliability (reduced fading), or increased antenna directivity.

“Channel estimation” is used herein to refer to estimation of channel state information (CSI) which describes properties of a communication link such as signal to noise ratio “SNR” and signal to interference plus noise ratio “SINR”. Channel estimation may be performed by user equipment or APs as well as other components operating in a communications system.

The term “beamforming” sometimes referred to as “spatial filtering” as used herein, is a signal processing technique used in antenna arrays for directional signal transmission or reception. This is achieved by combining elements in the array in such a way that signals at particular angles experience constructive interference while others experience destructive interference. Beamforming can be used at both the transmitting and receiving ends in order to achieve spatial selectivity. The operation of attempting to achieve destructive interference in order to cancel a signal in a particular direction or angle is referred to as “nulling”. Complete cancellation of a signal is not usually achieved in practice and a “null” in a radiation pattern may refer to a minimum in signal strength. The lower the signal strength, the “deeper” the null is said to be.

The term “beamformer” as used herein refers to analog and/or digital circuitry that implements beamforming and may include combiners and phase shifters or delays and in some cases amplifiers and/or attenuators to adjust the weights of signals to or from each antenna in an antenna array. Digital beamformers may be implemented in digital circuitry such as a digital signal processor (DSP), field-programmable gate array (FPGA), microprocessor or the central processing unit “CPU” of a computer to set the weights as may be expressed by phases and/or amplitudes of the above signals. Various techniques are used to implement beamforming including: Butler matrices, Blass Matrices and Rotman Lenses. In general, most approaches may attempt to provide simultaneous coverage within a sector using multiple beams.

### SUMMARY

Wi-Fi is a time division duplex system (TDD), where the transmitting and receiving functions use the same channel, implemented with a limited amount of frequency resources that use techniques of collision avoidance (CSMA/CA) to allow multiple stations, user equipment's (UEs) and APs, to share the same channel.

In many deployments APs on the same radio channel are within CCA range of each other. Thus an AP maybe blocked from transmitting to its client STA (typically a UE) due to activity of a nearby AP as noted in FIG. 1.

Multi-User MIMO (MU_MIMO) capable APs can develop complex antenna patterns that support simultaneous enhancing and nulling in specific directions. According to embodiments of this invention, nulling at one AP may be set toward a co-channel AP in order to achieve the combined effect of reducing interference to the co-channel AP and reducing interference from the co-channel AP. The quality of this null, e.g. the effectiveness of the interference reduction, can be enhanced through the use of CSI information exchanged between the one AP and the co-channel AP. However it is not provided as part of the over-the-air (OTA) standard for APs to communicate with each other.

According to embodiments of the invention, an access point or components within the AP, e.g., a processor or baseband processor, or radio circuitries, is configured to exchange messages with at least one associated station (STA) over a wireless, or over-the-air channel. The AP may comprise a plurality of antennas, radio circuitry configured to transmit and receive via said antennas and a baseband processor, and may be equipped with beamforming capability. According to embodiments of the invention, the baseband processor is configured to establish a backhaul link with at least one neighboring AP which may be operating within a clear channel assessment (CCA) range of said AP. The AP may then transmit or send a sounding packet to its at least one associated STA over-the-air, or via the wireless channel, and obtain CSI feedback from said at least one neighboring AP via the backhaul link.

A method according to embodiments of the invention may be implemented in or by an AP and may include establishing a backhaul link with at least one co-channel neighboring AP, sending a sounding packet to said at least one associated STA over the wireless channel, and obtaining channel state information (CSI) feedback from said at least one co-channel neighboring AP via the backhaul link.

Embodiments of the invention may also be implemented in the neighboring AP. This may include establishing a backhaul link with at least one neighboring AP, detecting a sounding packet sent by the neighboring AP to at least one associated STA over the wireless channel, and sending channel state information (CSI) to said at least one neighboring AP via the backhaul link.

Embodiments of the invention may also comprise an AP that is configured to implement both methods described above, whereby an AP can transmit or send or receive CSI via a backhaul link with another AP.

An AP according to embodiments of the invention is sometimes referred to in the following as a “beamforming AP” to distinguish it from a neighboring AP. A beamformng AP may also be referred to as a MIMO AP. The neighboring AP may or may not have beamforming capability.

According to embodiments of the invention, an AP equipped with beamforming capability can both enhance its signal to its client STA while simultaneously nulling its signal toward a neighboring AP which may be interfering. According to embodiments of the invention this can be achieved by providing to the beamforming AP CSI relating to the neighboring AP.

CSI can be derived by the neighboring AP either implicitly or explicitly. The use of the term “implicit” or “implicitly” in this context refers to a process used for TDD protocols such as Wi-Fi, where both down and up links share the same spectrum. In the aforementioned process, the uplink channel estimated by an AP is assumed to be identical to the downlink one, based on the reciprocity principle. Therefore, in an example of this process, the channel from an STA towards an AP is considered by the AP to represent the channel from the AP towards the STA. Conversely, the use of the term “explicit” or “explicitly” in this context refers to a procedure where CSI is fed back. In an example of an explicit process between AP and STA, AP transmissions are channel estimated by the STA, and then fed back to the AP, providing the AP with, for example, the magnitude of phase and amplitude differences between the signals as transmitted by the AP vis-a-vis as received by the client/STA. Such information may allow the AP to gauge possible distortions in signals and correct them.

According to embodiments of the invention, CSI is provided that relates to a channel between one AP and another. There is no provision in the Wi-Fi standards for APs to communicate directly with each other. Therefore although one AP may receive, or detect, transmissions from another AP that are not directed to it, no mechanism is provided for it to respond using Wi-Fi protocol.

Explicit feedback is more accurate, and therefore more useful for generating a high quality null toward a STA or an AP. Embodiments of the invention enable explicit CSI measurement between compatible APs so that inter AP interference can be reduced, “compatible” referring to APs according to embodiments of the invention. However high quality of this kind may not always be required and embodiments of the invention may use implicit CSI.

APs having the capability to implement embodiments of the invention may register with a controller via the backhaul, for example in order to obtain the address of a neighboring AP. This controller may take the form of a server, for example, and is referred to in the following as a sounding controller. According to other embodiments of the invention a new procedure is developed that enables an AP to establish a direct peer-to-peer (P2P) backhaul link with a nearby compatible AP which bypasses the sounding controller to reduce CSI feedback delay.

Embodiments of the invention may also comprise a system comprising multiple APs, each configured to implement any of the foregoing methods, as well as a sounding controller for registration of said APs, each AP being configured to register with the sounding controller.

Embodiments of the invention comprise a method whereby an AP may obtain feedback, for example explicit feedback, from a co-channel AP as an extension of the standard procedure of obtaining CSI information from a UE or other STA which it is supporting. According to embodiments of the invention, an AP may transmit or send a sounding packet to its associated STAs, poll feedback from STAs and receive backhaul feedback from one or more neighboring APs. According to embodiments of the invention this may be achieved with no additional Wi-Fi overhead in the physical layer, e.g. channel occupancy. In this manner an AP may have timely CSI , for example based on feedback from a co-channel AP, which by its nature may be explicit, enabling it to develop a high quality null toward that AP.

According to other embodiments of the invention an AP may dynamically adjust any of the sounding rate, the sounding data quality and the specific STA to which sounding is directed, for example based on changes in environment.

According to other embodiments of the invention, when a beamforming AP has data to send to a supported UE or other STA and finds that its own channel is not clear, for example due to the CCA having been set by one or more other APs, then the beamforming AP may determine whether the quality of the CSI data that it possess will enable it to to reduce the transmission of the beamforming AP toward one or more of the other APs. This reduction in transmission may be achieved with a pattern that has one or more nulls reduce the transmission of the beamforming AP toward one or more other concurrently operating APs. This may enable the beamforming AP not to interfere with the activity of the one or more other concurrently operating APs. The beamforming AP may then be able to deliver an acceptable signal to a UE or other STA which it is supporting. If a beamformer AP can meet this criteria, it may proceed to send data to the UE or other STA.

As stated above, according to embodiments of the invention, a beamformer AP determines if the CSI data it has at this specific moment is of sufficient quality. The AP's analysis may consider any of (a) how many milliseconds have elapsed since the last CSI update it received, (b) the stability of the CSI data—e.g. how rapidly is it changing and (c) the absolute quality of the CSI data versus what is required for sufficient nulling depth.

### BRIEF DESCRIPTION OF THE DRAWINGS

For a better understanding of the invention, and in order to show how it may be implemented, references are made, purely by way of example, to the accompanying drawings in which like numerals designate corresponding elements or sections.

FIG. 1 shows a typical operational environment with multiple APs in CCA range according to embodiments of the invention;

FIG. 2 is a block diagram illustrating an AP within CCA range of a neighboring AP, in accordance with some embodiments of the present invention.

FIG. 3 illustrates an example of backhaul based sounding feedback system comprising two APs and a sounding controller connected by a IP network for backhaul based sounding feedback, according to embodiments of the invention;

FIG. 4 shows an example of an802.11 AC MU-MIMO sounding message flow according to embodiments of the invention;

FIG. 5 shows a high level message flow of backhaul based sounding feedback among a beamformer AP, a neighboring AP and a sounding controller according to embodiments of the invention;

FIG. 6 illustrates a process flow of a neighboring AP receiving a sounding message and sending a backhaul based CSI feedback message according to embodiments of the invention; and

FIG. 7 illustrates a flow chart of beamformer AP determining to ignore the NAV set by another AP and proceed to send data to a UE, or to wait for channel is clear according to embodiments of the invention;

FIG. 8 illustrates how an AP equipped with beamforming can null its signal toward an interfering AP while transmitting to its client STA (a UE) in a typical operational environment with multiple APs in CCA range, according to embodiments of the invention; and

FIG. 9 shows the structure of the frame used in a beacon transmission, where backhaul CSI feedback capability is indicated in the optional vendor specific portion of the frame in accordance with some embodiments of the present invention.

The drawings together with the following detailed description are designed make the embodiments of the invention apparent to those skilled in the art.

### DETAILED DESCRIPTION OF EMBODIMENTS OF THE INVENTION

It is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

The invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

In description that follows, APs are assumed to operate in 40 MHz band, with 4 antennas and use 400 nanosecond inter-symbol spacing. The ideas described can be adjusted for other bandwidths and other AP antenna configurations. In the following, an asterisk, e.g. AP*, indicates that an AP is compatible with backhaul based CSI feedback according to embodiments of the invention. This may mean for example that an AP is equipped with software, for example installed in the baseband processor, so that it can participate in backhaul based CSI feedback, either as a sounder or as a responder. AP*_1 refers to an AP that initiates registration with a sounding controller on its backhaul network, sometimes referred to in the following as a beamforming AP. AP*_i, where i {2 . . . n} is a designator for the different AP*s that are members of backhaul based sounding feedback links with AP*_1, some of which may be referred to as neighboring APs.

APs according to embodiments of the invention may use an unmodified 802.11ac Null Packet Protocol procedure to transmit or send sounding, which may be received by all compatible APs as well as STAs within CCA range. An AP may then receive other APs' CSI feedback from one or more backhaul links. AP*_1 may build or compile a table or other data structure storing most recent CSI values for each AP*_i that has been sounded. When AP*_1 has data to send to a UE and finds one or more AP*_i has triggered CCA, AP*_1 may determine whether an antenna pattern can be created by it that will: null concurrent one or more AP*_i so that AP*_1's radiation toward the one or more AP*_i is below a CCA limit; and create acceptable beam toward UE_1. If such a pattern can be created, AP*_1 may create the pattern and proceed to send data to the UE.

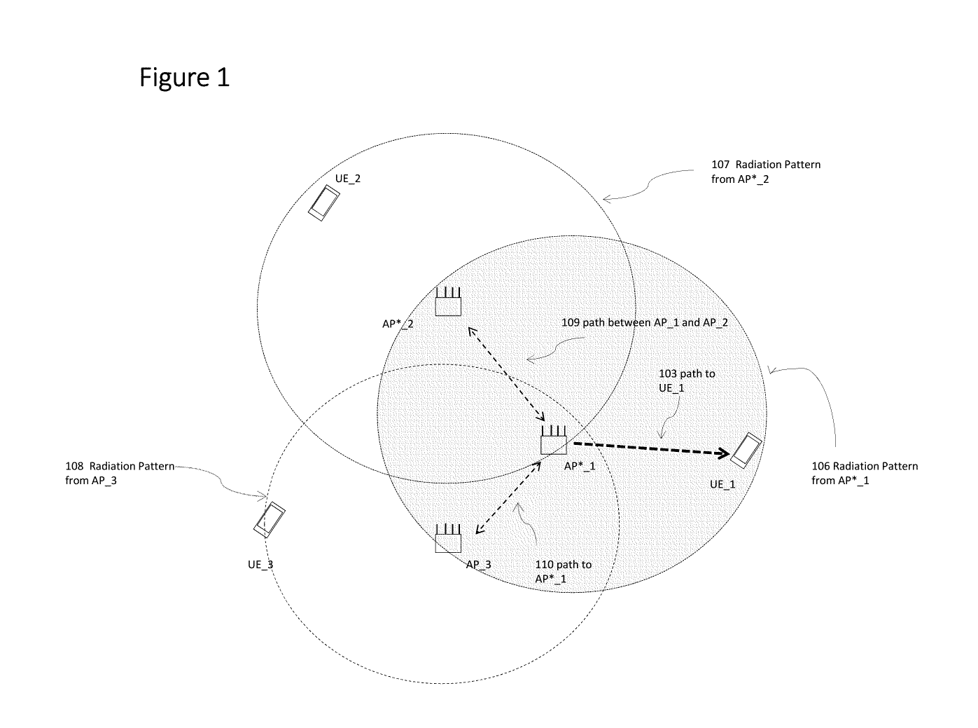

FIG. 1 shows a basic Wi-Fi environment including multiple neighboring co-channel APs, AP*_1, AP*_2 and AP_3 and respective associated stations (STAs), which in this embodiment are shown as UEs, UE_1, UE_2 and UE_3. AP*_i where i {2 . . . n} indicates an AP that has the capability to implement embodiments of this invention, which may for example be implemented in the form of a software enhancement. For example, hardware described herein may be configured to carry out embodiments of the present invention by executing software or code. AP*_1 is going to transmit or send MU_MIMO data to UEs supported by it, one of which is UE_1, and will sound them prior to sending data. Supposing that AP*_2 is considered by AP*_1 to be a good candidate to null, determined by relative signal levels, geometry, etc., AP*_1 will start the sounding procedure when the NAV for AP*_1 is NOT set, meaning the channel is clear and all the APs in CCA range are not active.

Each of AP*_1, AP*_2 and AP_3 may have a radiation pattern shown in FIG. 1 as a circle centered on the respective AP, for example pattern 106 for AP*_1, 107 for AP*_2 and 108 for AP_3. FIG. 1 also shows propagation path 103 between AP*_1 and UE_1, propagation path 109 between AP*_1 and AP*_2, and propagation path 110 between AP_3 and AP*_1.

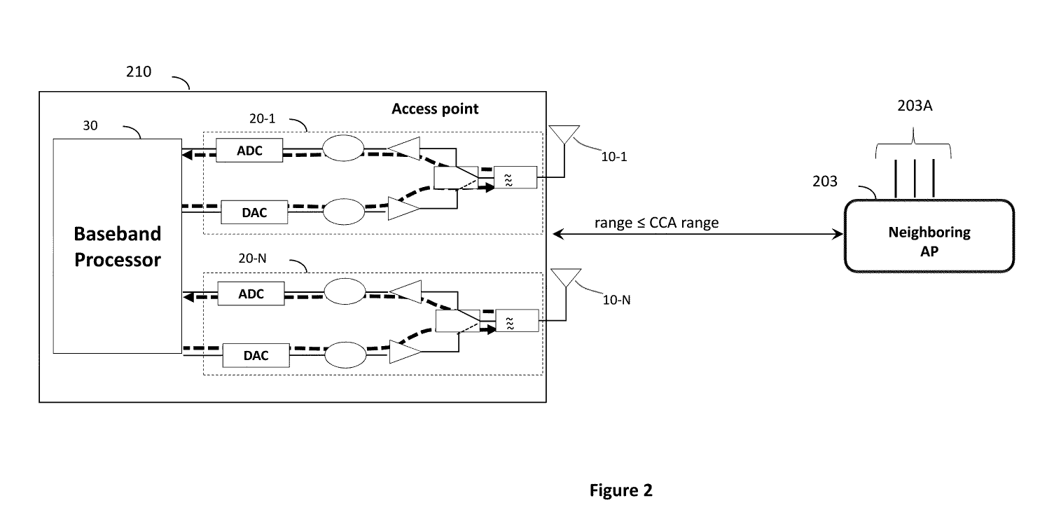

FIG. 2 is a block diagram illustrating an AP 210 within CCA range of a neighboring AP 203, in accordance with some embodiments of the present invention. AP 210 may include for example a plurality of antennas 10-1 to 10-N, radio circuitry in the form of a plurality of radio circuits 20-1 to 20-N configured to transmit and receive signals via respective antennas 10-1 to 10-N in compliance with the IEEE 802.11 standard, and a baseband processor 30. AP 210 may be configured to transmit and receive signals within a clear channel assessment (CCA) range of neighboring AP 203 which has a plurality of antennas 203A and may be configured to transmit and receive signals in a co-channel shared with AP 210 in compliance with the IEEE 802.11 standard.

Baseband processor 30 may be configured to monitor signals received by the radio circuits 20-1 to 20-N and generate a set or list of neighboring co-channel access points that each has plurality of antennas and are further located within a clear channel assessment (CCA) range of the access point. Baseband processor 30 may be further configured to instruct radio circuits 20-1 to 20-N to transmit a sounding sequence to the list of neighboring access points, and receive Channel State Information (CSI) therefrom. The sounding sequence may comprise a sequence of control frames sent to beamformees and data frames indicative of the channel from the beamformee.

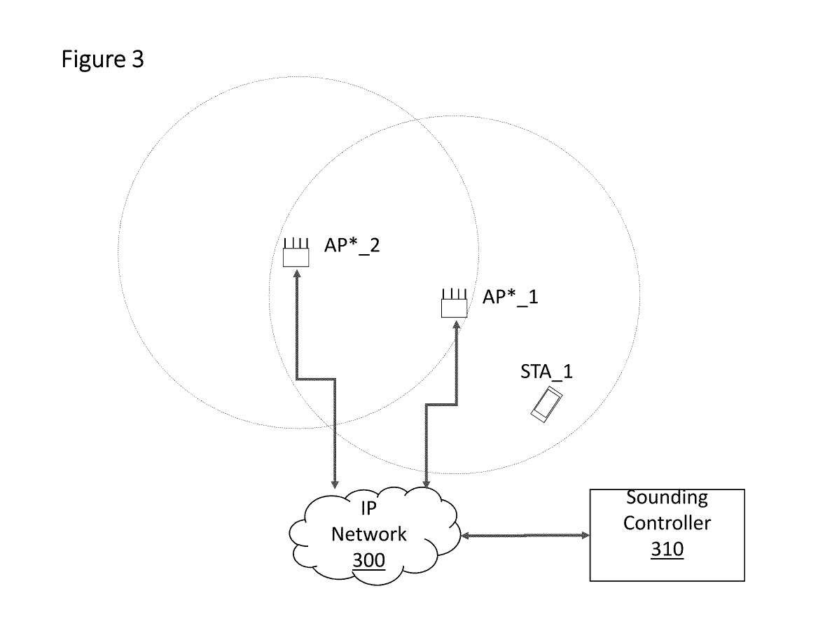

FIG. 3 illustrates an example of a backhaul-based sounding feedback system according to embodiments of the invention. The system as illustrated in FIG. 3 comprises two APs, labelled AP*_1 and AP*_2, and a sounding controller 310 connected by an IP network 300 for backhaul based sounding feedback according to embodiments of the invention. In the illustrated system it is assumed that AP*s are within CCA range of each other to establish a backhaul CSI feedback link between them on an IP network. A channel sounding packet is sent from AP*_1 over-the-air, for example using a wireless channel, in this example via Wi-Fi communication. The packet may be addressed to its associated STAs, e.g., STA_1 in FIG. 3, and may also be received by neighboring AP*s, e.g. AP*_2. STAs may transmit or send their CSI feedback over-the-air, e.g. over a wireless channel, for example as standard procedures defined in 802.11n or 802.11ac. According to embodiments of the invention, at the same time, neighboring AP*s send their CSI feedback through a backhaul link comprising IP network 300. There is no need for any change to Wi-Fi air interface protocol for backhaul based sounding feedback and no additional overhead requirement in Wi-Fi physical layer according to embodiments of the invention.

As will become clear in the following, the sounding controller 310 may function in a similar manner to a server. The sounding controller 310 does not need to be a stand-alone item and its functions may be incorporated into another component, such as an existing server in the IP network.

802.11n channel sounding has two PPDU formats defined: the regular or staggered PPDU, which carries a MAC frame, and the null data packet (NDP), which does not carry a MAC frame. According to embodiments of the invention, the NDP is used in a sequence from which the addressing and other MAC related information can be obtained from a MAC frame in a preceding PPDU. The normal or staggered PPDU is simply a normal PPDU or a PPDU with additional HT-LTFs that is used to sound the channel. It serves the dual purpose of sounding the channel and carrying a MAC frame. The NDP is only used to sound the channel.

Two sequences of NDP as sounding PPDU are possible for 802.11n channel sounding: The first sequence is that NDP frame may follow another PPDU where the preceding PPDU carries one or more MPDUs which contain the HT Control field with the NDP Announcement bit set to 1. The second possible sequence is when the NDP Announcement PPDU solicits an immediate response then the NDP itself follows the response PPDU from another STA.

Unlike 802.11n, the 802.11ac sounding sequence is separate from the data sequence. Explicit feedback is the mechanism for obtaining CSI (there is no implicit feedback). Only compressed-V (in the singular value decomposition “SVD” of the channel) beamforming weights are permitted (uncompressed-V and CSI are not supported). There is no support for delayed feedback. Rather, in implementations according to 802.11ac, feedback is returned during the SIFS after receiving the VHT NDP. The VHT sounding sequence begins with a VHT NDP Announcement frame sent by the beamformer and addressed to the beamformees. This is followed by a VHT NDP frame for channel sounding. The first beamformee responds SIFS after the VHT NDP with a VHT Compressed Beamforming frame. The remaining STAs are polled in turn with a Beamforming Report Poll frame to which they respond with their VHT Compressed Beamforming frame.

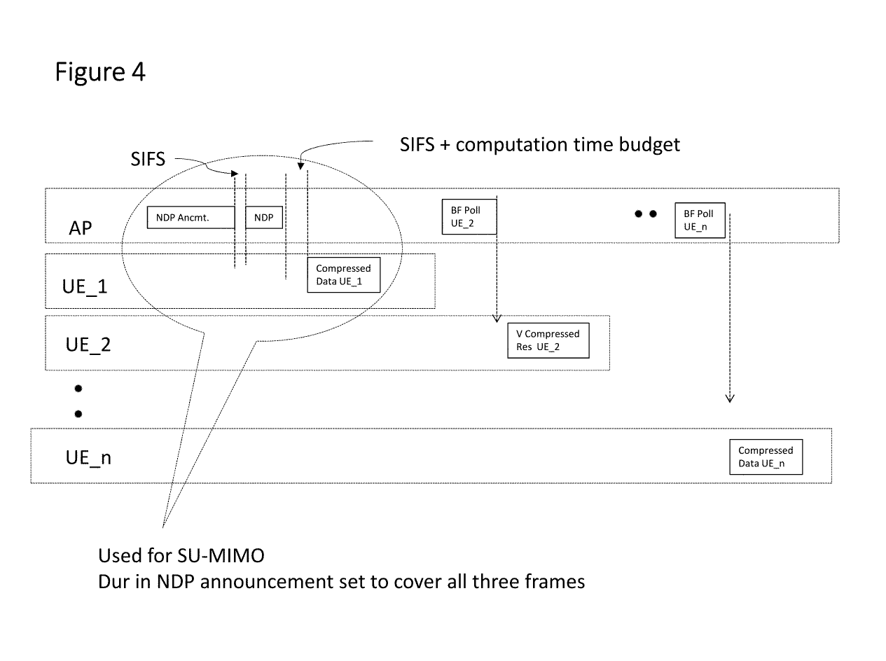

FIG. 4 shows by way of example a standard 802.11ac MU-MIMO sounding message flow: an AP transmits or sends an NDP_announcement, followed by an NDP. The STA that was addressed in the receiver field of the NDP_announcement is expected to respond with compressed CSI information. After that, the AP polls the “other” STAs. The “other” STAs know they might be polled as they are part of the association identifier (ID) “AID” list which is part of the NDP_announcement message. This same message flow may be used without modification in embodiments of the invention. The same applies to standard 802.11n channel sounding message flows.

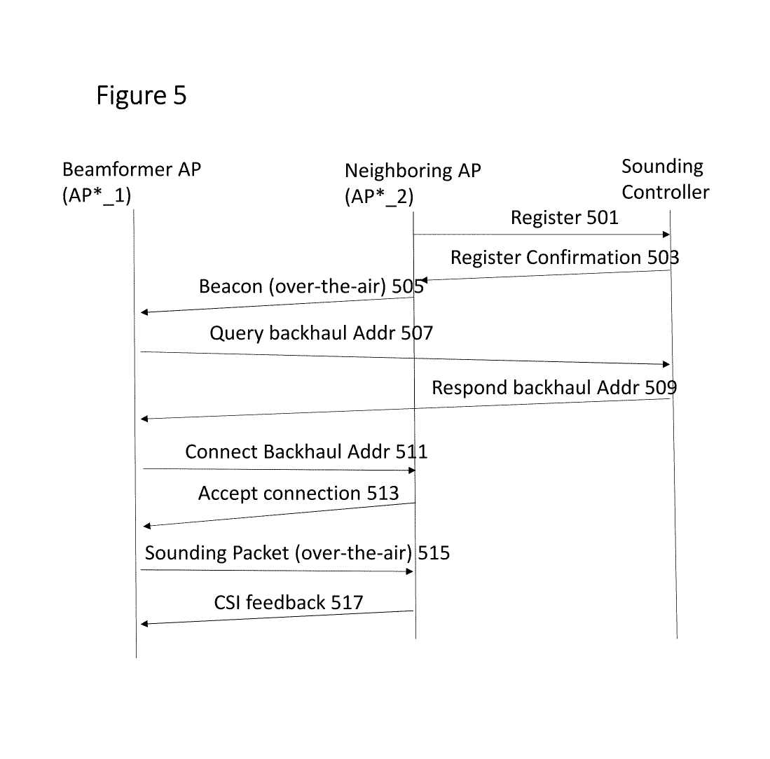

FIG. 5 shows a high level message flow of backhaul based sounding feedback among a beamformer AP, AP*_1, a neighboring AP, AP*_2 and a sounding controller such as sounding controller 310 of FIG. 3 according to embodiments of the invention. Initially, neighboring AP*_2 registers it backhaul IP address, Wi-Fi SSID and Wi-Fi MAC address with a sounding controller on its backhaul network, e.g. IP network 300, at power-up in flow 501. In flow 503, AP_*2 receives a register confirmation on the backhaul network from the sounding controller 310. After registration is confirmed in flow 503, the neighboring AP*_2 broadcasts its backhaul CSI feedback capability in beacon transmissions over the air to other APs including AP*_1, as indicated by flow 505. AP*_1, which is a beamformer AP receives a beacon transmission 505 from the neighboring AP*_2 and recognizes neighboring AP*_2′s backhaul CSI feedback capability. Next, beamformer AP*_1 sends or transmits a query to the sounding controller 310 in flow 507 about neighboring AP*_2′s backhaul IP address. This may be done using the decoded MAC transmitter address in received beacon transmission 505. The sounding controller 310 responds with the backhaul address in flow 509. Beamformer AP*_1 then transmits or sends a connection request to AP*_2 in flow 511 and receives an accepted response in flow 513 to/from the neighboring AP*_2 to establish a direct backhaul CSI feedback link, a peer-to-peer (P2P) link which bypasses the sounding controller 310 to reduce CSI feedback delay.

After the neighboring AP*_2 receives a sounding packet, a null data packet (NDP) or a data packet with extension HT-LTFs, from the beamformer AP*_1 in flow 515, in response the neighboring AP*_2 transmits or sends a CSI feedback in flow 517 directly to beamformer AP*_1 through the backhaul link. It should be noted that according to embodiments of the invention, the CSI feedback is transmitted or sent to AP*_1 by AP*_2 regardless of addressed devices for the sounding packet or other packet sent in flow 515. Such packets are usually addressed to STAs served by the sending AP. However they may be detected and decoded by any AP within CCA range of the sending AP. After receiving CSI feedback in flow 517, according to embodiments of the invention AP*_1 may update a CSI table with most recent CSI for AP*_2. The same process may apply to any other AP*_i that sends feedback to AP*_1. Operations 515 and 517 may be repeated once the peer-to-peer link is established. In other words there is no need for operations 501 to 513 to be repeated before AP*_1 sends further sounding packets to its associated stations and AP*_2.

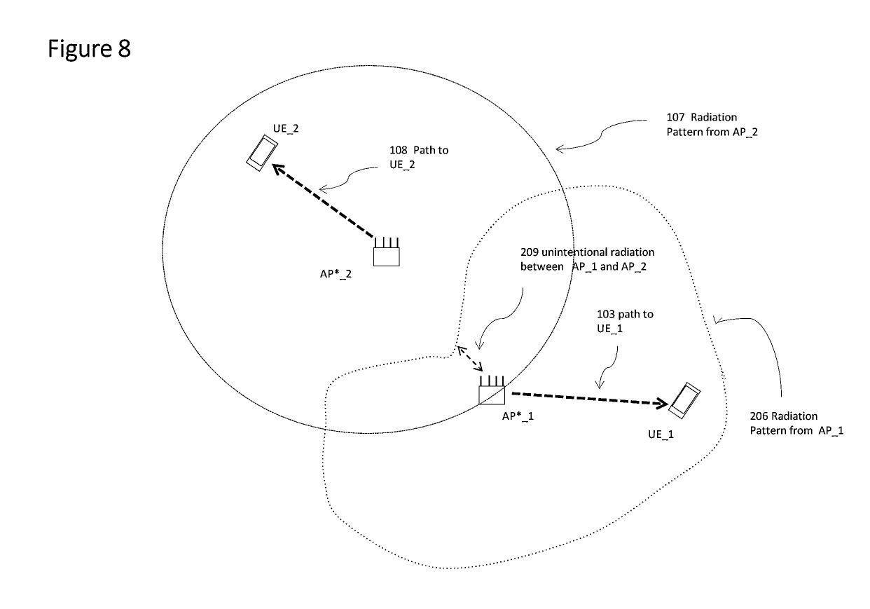

After receiving CSI feedback at the end of the process flow shown in FIG. 5, beamformer AP*_1 applies the CSI feedback to create a radiation pattern , also known as a spatial signature, having a null in transmission or reception toward the neighboring AP*_2. This may reduce interference between the two APs, AP*_1 and AP*_2, for example while beamformer AP*_1 is transmitting or sending a packet to its associated STA. The creation of the radiation pattern is explained with reference to FIG. 8 below.

For the least quantization distortion, CSI feedback uses 8 bits for each real and 8 bits for each imaginary component of the channel complex element between a transmit antenna and a receive antenna per subcarrier which would have less quantization distortion than compressed-V beamforming frame used in 802.11ac. Grouping of two or four subcarriers can be used to reduce CSI feedback overhead.

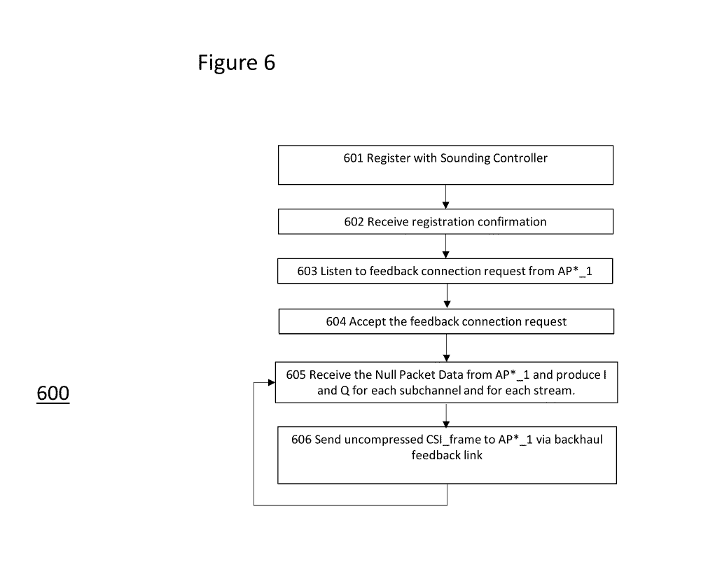

FIG. 6 shows the process flow 600 in a neighboring AP, labelled AP*_i according to embodiments of the invention. In operation 601, AP*_i registers its backhaul IP address, Wi-Fi SSID and Wi-Fi MAC address with a sounding controller, e.g. sounding controller 310, on its backhaul network, e.g. IP network 300 at power-up and receives the registration confirmation from the sounding controller in operation 602. Then AP*_i listens for a feedback link connection request, for example from AP*_1 in operation 603 and accepts the backhaul feedback connection request to establish a direct peer-to-peer connection for sounding feedback in operation 604. According to embodiments of the invention, the real and imaginary components I and Q of the channel information are uncompressed and prepared for transmission. When a sounding packet from AP*_1 is received by AP*_i at operation 605, AP*_i transmits or sends the CSI data in operation 606 via the established backhaul feedback link. Then AP*_i goes back to operation 605 where it continues to receive next sounding packet from AP*_1.

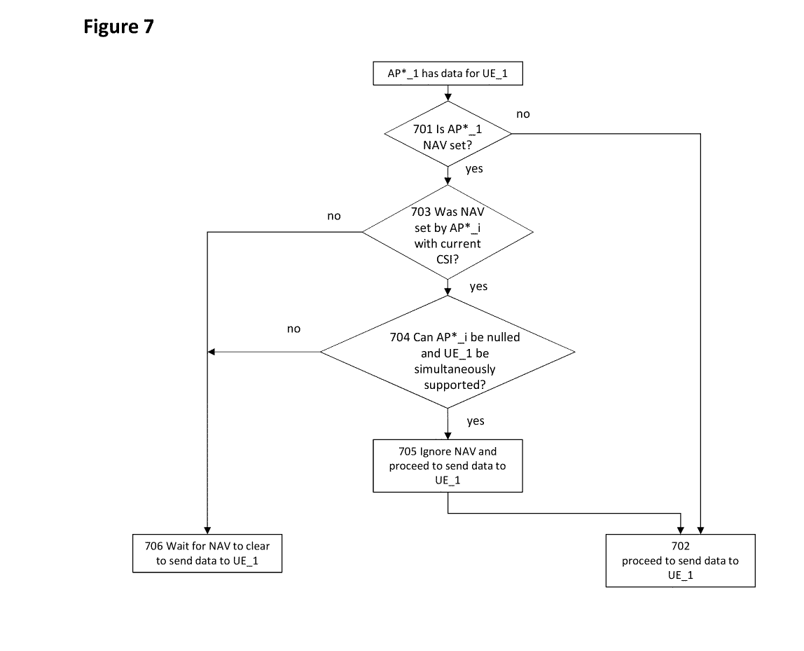

FIG. 7 shows the process flow in a beamformer AP, labelled AP*_1, according to embodiments of the invention, for transmitting or sending data to an associated STA, labelled UE_1. When AP*_1 has data to send to UE_1, it checks to see if NAV is set at operation 701. If not, e.g. the channel is not clear, AP*_1 proceeds to send data at 702. However if NAV is set, then AP*_1 determines if the NAV was set by one of its neighboring APs, AP*_i, that has backhaul CSI feedback capability. AP*_1 checks if the CSI data from the neighboring AP, AP*_i, is current or not at operation 703. Using this current CSI data, AP*_1 determines whether it can reduce its radiation pattern, e.g. generate a null, toward AP*_i sufficient to protect it from interference from AP*_i , for example by checking whether it will be protected by the CCA set threshold e.g. -82dB, and also support UE_1 at operation 704. If this condition can be met, AP*_1 may ignore the NAV being set and proceed to send data to UE_1 at operation 705. If this condition is not met, then it wait until NAV clears at operation 706. There might be two active neighboring AP*s and it might be possible for AP*_1 to create multiple nulls.

Some embodiments of the invention do not require a modification to the NDP_announcement and NDP messages. Consequently, the various STAs will see the message flows as standard. AP*_1 receives CSI information from each of the associated UEs that it polls over the Wi-Fi air interface, for example as the standard MU_MIMO sounding procedure. In addition, according to embodiments of the invention, AP*_1 receives CSI information from AP*_2 via an established backhaul link as shown in FIGS. 3 and AP*_1 may then generate a pattern as shown in FIG. 8.

FIG. 8 shows how an AP, AP*_1, equipped with beamforming capability can both enhance its signal to a client STA, UE_1, while simultaneously nulling its signal toward an interfering AP, AP*_2. In FIG. 8, the same reference numerals are used to designate like items in FIG. 1. In FIG. 8, the propagation path between AP*_1 and AP*_2 is modified and referenced 209, and the overall radiation pattern is modified and referenced 206.

AP*_1 performs the enhancement and nulling using CSI on the path 209 (109) between APs and on the path 103 between AP*_1 and UE_1. The baseband processor in an AP according to embodiments of the invention may be configured to apply weights to signals received by or transmitted from AP antennas such that spatial signatures, or radiation patterns, generated in downlink or uplink or both reduce interferences between said Wi-Fi AP and at least one of the N neighboring APs. The application of these weights may be based for example on received CSI feedback from sounding. At the same time the AP may transmit or send a data packet to a station (STA), or a group of stations.

FIG. 8 illustrates schematically that the modification of the radiation pattern results in a reduction of unwanted or unintentional radiation between the two APs, as indicated by path 209. At the same time the radiation between AP*_1 and UE_1 may be enhanced as indicated by the extension of the radiation pattern 206 around UE_1.

CSI can be developed either implicitly or explicitly. The use of explicit feedback is more accurate, and therefore more useful that implicit feedback for generating a high quality null toward a neighboring AP.

According to embodiments of the invention, AP*_1 is able to recognize nearby APs that are AP* compatible and able to support communication between them. AP* capability can be added in as an information element in the beacon transmission.

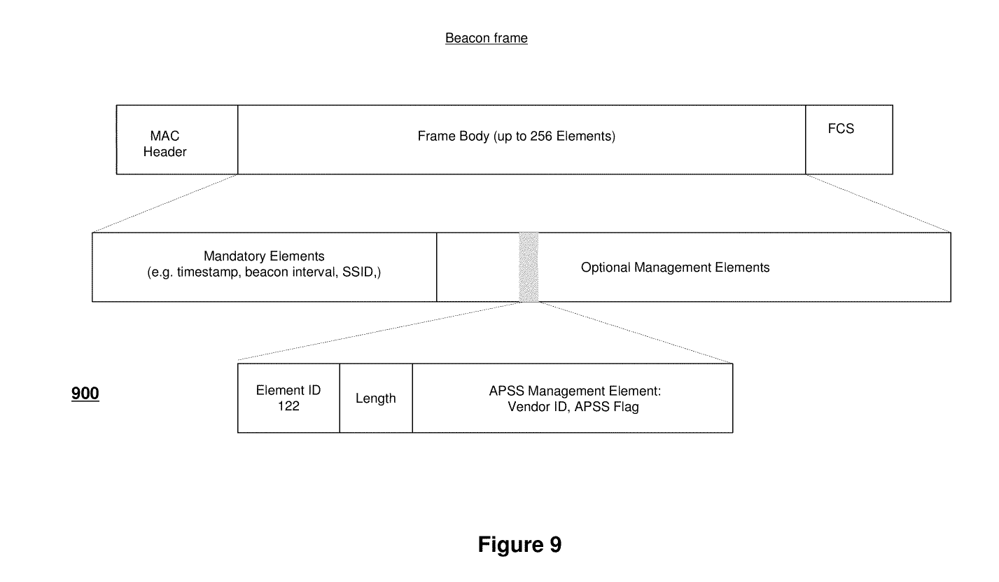

FIG. 9 is a diagram illustrating the structure of the 802.11 Beacon Frame 900 in accordance with embodiments of the present invention. This frame is transmitted by all 801.11 APs at a periodic rate, typically 10 times per second. This beacon includes mandatory information such as the SSID of the AP but can optionally include other information, e.g. vendor specific data. According to embodiments of the invention, the vendor specific data may start with a device/vendor ID followed by a flag to indicate backhaul CSI feedback capability. Where this becomes standardized, a specific Information Element ID could be assigned to indicate this capability rather than embedding this information in a vendor specific data element.

According to embodiments of the invention, an AP may obtain explicate feedback from a co-channel AP as an extension of the standard procedure of obtaining CSI information from its supported UE. In this manner the AP will have timely CSI information based on feedback from the co-channel AP, enabling it to develop a high quality null toward that AP. Embodiments of the invention do not require a modification to the standard sounding approach used by AP*_1 when it sends the NDP_announcement message. Consequently, the various STAs will see the message flows as standard. AP*_1 receives CSI information from co-channel neighboring AP, AP*_i, via an established backhaul link between them and from each of its associated UEs over the Wi-Fi air interface that it polls as the standard MU_MIMO sounding procedure, and then AP*_1 generates a pattern as shown in FIG. 8.

The methods described for embodiments of this invention can be implemented in hardware, combination of hardware and software or software only. A unique aspect of some embodiments is the possibility for implementation completely in software, for example by augmenting the notational algorithms of the 802.11xx protocol. Thus embodiments of the invention may take the form of one or more computer readable media, e.g. non-transitory computer readable media, which when implemented on one or more processors in an AP system to perform any of the methods described above.

The methods described herein are applicable to all versions of the 802.11 protocol, specifically 802.11a, b, g, n and ac.

As will be appreciated by someone skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” In one aspect the invention provides a computer readable medium comprising instructions which when implemented on one or more processors in a computing system causes the system to carry out any of the methods described above. The computer readable medium may be in non-transitory form.

The aforementioned block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method implemented in an access point (AP) configured to exchange messages with at least one associated station (STA) via a wireless channel, the AP comprising: a plurality of antennas, radio circuitry configured to transmit and receive via said antennas, and a baseband processor, the method comprising:
establishing a backhaul link with at least one co-channel neighboring AP, sending a sounding packet to said at least one associated STA over the wireless channel, and
obtaining channel state information (CSI) feedback from said at least one co-channel neighboring AP via the backhaul link.

2. The method according to claim 1 wherein the at least one co-channel neighboring AP is operating within a clear channel assessment (CCA) range of said AP.

3. The method according to claim 1 wherein establishing said backhaul link comprises:
transmitting a query for an address of said at least one co-channel neighboring AP; and
receiving a response comprising an address for each said at least one co-channel AP.

4. The method according to claim 3 comprising:
sending said query to a controller,
receiving said response from said controller, and
establishing said backhaul link with said at least one co-channel neighboring AP as a peer-to-peer (P2P) link which bypasses said controller.

5. The method according to claim 1 further comprising:
determining that the radiation pattern of the AP towards said at least one co-channel neighboring AP can be reduced sufficient to protect the AP from interference from the at least one co-channel neighboring AP; and
generating a radiation pattern that is reduced towards said at least one co-channel AP.

6. The method according to claim 5 further comprising exchanging messages with at least one associated station (STA) via a wireless channel at the same time as generating said reduced radiation pattern.

7. The method according to claim 6 comprising, prior to said determining, generating and exchanging, determining that a network allocation vector (NAV) for the channel is set.

8. The method according to claim 7 comprising prior to said determining, generating and exchanging, determining that the NAV has been set by one said co-channel neighboring AP.

9. The method according to claim 7 wherein said determining uses CSI, obtained via a backhaul link, for a co-channel neighboring AP that has set the NAV.

10. The method according to claim 1 in which said obtaining comprises obtaining CSI for multiple co-channel neighboring APs and the method further comprises comprising compiling a table of most recently obtained CSI for said multiple co-channel neighboring APs.

11. The method according to claim 1 further comprising detecting a sounding packet sent by a co-channel neighboring AP via a wireless channel to at least one STA associated with the neighboring AP, and in response to said detecting sending CSI to said at least one neighboring AP via a backhaul link.

12. An access point (AP) configured to exchange messages with at least one associated station (STA) via a wireless channel, the AP comprising:
a plurality of antennas,
radio circuitry configured to transmit and receive via said antennas, and
a baseband processor,
wherein the baseband processor is configured to cause the AP to:
establish a backhaul link with at least one co-channel neighboring AP,
send a sounding packet to said at least one associated STA over the wireless channel, and obtain channel state information (CSI) feedback from said at least one neighboring AP via the backhaul link.

13. The system according to claim 12, wherein the said the baseband processor is configured to determine one or more weights for signals transmitted to or received from said antennas to generate a radiation pattern to reduce interference between said AP and at least one co-channel neighboring AP based on said CSI feedbaack.

14. The AP according to claim 12 wherein the radio circuitry is configured to operate in compliance with the IEEE 802.11 standard.

15. The AP according to claim 12, wherein the sounding packet is sent according to the MU-MIMO sounding protocol.

16. The AP according to claim 12, configured to obtain said CSI feedback from said at least one neighboring co-channel APs via a backhaul link and from its associated STAs over-the-air according to the MU-MIMO sounding protocol.

17. The AP according to claim 1, the baseband processor is configured to query the sounding controller about the neighboring AP's backhaul IP address by decoded MAC transmitter address in received beacon.

18. An access point (AP) configured to exchange messages with at least one associated station (STA) via a wireless channel, the AP comprising:
a plurality of antennas;
radio circuitry configured to transmit and receive via said antennas and
a baseband processor,
wherein the baseband processor is configured to establish a backhaul link with at least one neighboring AP, to detect a sounding packet sent by the neighboring AP to at least one associated STA over the wireless channel, and to send channel state information (CSI) to said at least one neighboring AP via the backhaul link.

19. The AP according to claim 18 further configured to indicate that it is capable of responding to sounding packets by transmitting identification of this capability.

20. The AP according to claim 18 in which the identification of this capability is transmitted in a beacon management frame of the AP.

21. The AP according to claim 18, configured to operate in compliance with the IEEE 802.11 standard and to register its backhaul IP address, Wi-Fi SSID, and Wi-Fi MAC address to a sounding controller via a backhaul link at power-up.

22. A communication system comprising a plurality of access points (APs) each configured to exchange messages with at least one associated station (STA) via a wireless channel, establishing a backhaul link with at least one co-channel neighboring AP, send a sounding packet to said at least one associated STA over the wireless channel, and obtain channel state information (CSI) feedback from said at least one neighboring AP via the backhaul link, the system further comprising a sounding controller for registration of said APs, each AP being configured to register with said sounding controller.
